(19) United States
(12) Patent Application Publication
(10) Pub. No.: US 2025/0265947 A1
(43) Pub. Date: Aug. 21, 2025

(54) PRODUCT INFORMATION SYSTEMS AND METHODS

(71) Applicant: iSee Store Innovations, L.L.C., St. Louis, MO (US)

(72) Inventors: Steven Allen Brenner, St. Louis, MO (US); Blake Anderson, St. Louis, MO (US); Vikas Alluri, St. Louis, MO (US)

(73) Assignee: iSee Store Innovations, L.L.C., St. Louis, MO (US)

(21) Appl. No.: 19/201,131

(22) Filed: May 7, 2025

Related U.S. Application Data
(63) Continuation-in-part of application No. 18/347,807, filed on Jul. 6, 2023.
(60) Provisional application No. 63/389,962, filed on Jul. 18, 2022.
(60) Provisional application No. 63/410,307, filed on Sep. 27, 2022.
(60) Provisional application No. 63/420,786, filed on Oct. 31, 2022.
(60) Provisional application No. 63/387,103, filed on Dec. 13, 2022.

(51) Int. Cl. G09F 3/00; G09F 3/02; G09F 3/20

(52) U.S. Cl. CPC G09F 3/0297; G09F 3/20; G09F 2003/0279

(57) ABSTRACT

A product information system and method include a card having an insertion beam. The card retains a communication device configured to provide information regarding one or more products in response to being engaged by a device of an individual. A housing includes an insertion channel leading into an interior chamber. The insertion beam is configured to be inserted into the insertion channel. The housing is configured to retain the insertion beam within the interior chamber to secure the card to the housing.

### CROSS-REFERENCE TO RELATED APPLICATIONS

This application is a continuation-in-part of U.S. patent application Ser. No. 18/347,807, entitled “Product Information Systems and Methods,” filed Jul. 6, 2023, which, in turn, relates to and claims priority benefits from: (1) U.S. Provisional Application No. 63/389,962, entitled “Securing Assembly Having Communication Device,” filed Jul. 18, 2022, (2) U.S. Provisional Application No. 63/410,307, entitled “Securing Assembly,” filed Sep. 27, 2022, (3) U.S. Provisional Application No. 63/420,786, entitled “Securing Assembly Having Communication Device,” filed Oct. 31, 2022, and (4) U.S. Provisional Application No. 63/387,103, entitled “Securing Assembly Including a Suction Cup and a Coupling Layer Secured to the Suction Cup,” filed Dec. 13, 2022, each of which is hereby incorporated by reference in its entirety.

### FIELD OF THE DISCLOSURE

Examples of the present disclosure generally relate to product information systems and methods, such as can provide information about one or more products in response to being engaged by a device of an individual.

### BACKGROUND OF THE DISCLOSURE

Various commercial enterprises offer goods for sale. Many establishments offer a large number products for sale. Separate and distinct signs may be used to provide point of sale and product information for certain products. However, such signs occupy space, which may otherwise be used for products. Further, such signs may not provide sufficient information regarding a product. For example, the signs may not be large enough to provide sufficient details and information about a product.

### SUMMARY OF THE DISCLOSURE

A need exists for system and a method that allow an individual to quickly and easily determine information regarding a product, service, and/or the like.

With that need in mind, certain examples of the present disclosure provide a product information system including a housing, and a communication device coupled to the housing. The communication device is configured to provide information regarding one or more products in response to being engaged by a device of an individual.

The housing can include a rear panel secured to a front panel.

In at least one example, the housing includes a clip that removably retains a card. The card retains the communication device.

In at least one example, the clip includes a tap indicia. The tap indicia provides an area where the individual can tap the device to engage the communication device.

The card can include a plurality of defined slots configured to receive and retain reciprocal protrusions of the clip.

The card can includes one or both of a graphics or text regarding the one or more products.

In at least one example, the communication device is secured within folded portions of the card.

The product information system can also include a securing assembly coupled to the housing.

As an example, the securing assembly includes a moveable joint that moveably couples the housing to a mount. The moveable joint can be a ball and socket joint.

The securing assembly can include a flexible layer of nanotechnology gel.

In at least one example, the securing assembly comprises a suction cup assembly. The suction cup assembly can include a flexible layer of nanotechnology gel.

In at least one example, the securing assembly includes a stand.

The communication device can be secured to the securing assembly.

The securing assembly can include a suction cup and a suction securing nut. The communication device can be disposed between and within one or both of the suction cup and the suction securing nut. The securing assembly can also include an insert mount that fits within or around a stem of the suction cup. The communication device can be mounted on the insert mount.

The communication device can be secured to the suction cup. Optionally, the communication device can be secured to the suction securing nut.

In at least one example, the communication device includes a near field communication chip.

In at least one example, the housing includes a front ring removably secured to a rear ring. A central passage is formed through the ring. The communication device is aligned with the central passage.

In at least one example, the housing includes a front ring secured to a rear retainer. The rear retainer secures to a rail by a retaining clip and a tap screw.

Certain examples of the present disclosure provide a product information method including coupling a communication device to a housing; and providing, by the communication device, information regarding one or more products in response to the communication device being engaged by a device of an individual.

Certain examples of the present disclosure provide a product information system including a card including an insertion beam. The card retains a communication device. The communication device is configured to provide information regarding one or more products in response to being engaged by a device of an individual. A housing includes an insertion channel leading into an interior chamber. The insertion beam is configured to be inserted into the insertion channel. The housing is configured to retain the insertion beam within the interior chamber to secure the card to the housing.

In at least one example, the card also includes a main panel. The insertion beam downwardly extends from the main panel.

In at least one example, the insertion beam retains the communication device.

The insertion beam can be formed by a lower portion of an extension beam folded about a fold line. The communication device can be retained within a folded portion of the insertion beam.

In at least one example, the card also includes a slot, and the housing also includes a tab. The tab is retained within the slot when the housing retains the insertion beam. As a further example, the housing also includes one or more guide fins having ramped protuberances that push the slot onto the tab when the insertion beam is inserted into the insertion channel. As a further example, the housing also includes a lower stop, and lateral guide protuberances. The lower stop and the lateral guide protuberances are configured to restrain the insertion tab when inserted into the insertion channel.

The housing can include a front portion removably connected to a rear portion.

In at least one example, the housing also includes a button configured to be pressed to release the insertion beam from the insertion channel. The button can include a tap indicia, which provides an area where the individual can tap the device to engage the communication device.

In at least one example, the housing also includes a coupler including a flexible layer of nanotechnology gel configured to secure the housing to a surface.

Certain examples of the present disclosure provide a method including inserting the insertion beam of the card into the insertion channel of the housing; and retaining the insertion beam within the interior chamber.

### BRIEF DESCRIPTION OF THE DRAWINGS

FIG. 1 illustrates a front isometric view of a product information system, according to an example of the present disclosure.

FIG. 2 illustrates a front isometric view of the product information system receiving a smart card, according to an example of the present disclosure.

FIG. 3 illustrates a rear isometric view of the product information system, according to an example of the present disclosure.

FIG. 4 illustrates a rear isometric view of a front panel of a housing, according to an example of the present disclosure.

FIG. 5 illustrates a front isometric exploded view of the product information system, according to an example of the present disclosure.

FIG. 6 illustrates a front view of a card and a communication device, according to an example of the present disclosure.

FIG. 7 illustrates a front view of the card securing the communication device, according to an example of the present disclosure.

FIG. 8 illustrates a front isometric view of the card being coupled to the housing of the product information system, according to an example of the present disclosure.

FIG. 9 illustrates a front isometric view of the product information system having the card, according to an example of the present disclosure.

FIG. 10 illustrates a front isometric exploded view of a product information system, according to an example of the present disclosure.

FIG. 11 illustrates an isometric view of a product information system, according to an example of the present disclosure.

FIG. 12 illustrate a front view of the product information system of FIG. 11.

FIG. 13 illustrates a top view of the product information system of FIG. 11.

FIG. 14 illustrates a bottom view of the product information system of FIG. 11.

FIG. 15 illustrates a lateral view of the product information system of FIG. 11.

FIG. 16 illustrates an isometric front view of a housing, according to an example of the present disclosure.

FIG. 17 illustrates a front view of the housing of FIG. 16.

FIG. 18 illustrates a rear view of the housing of FIG. 16.

FIG. 19 illustrates a lateral view of the housing of FIG. 16.

FIG. 20 illustrates an isometric exploded view of a product information system, according to an example of the present disclosure.

FIG. 21 illustrates an isometric exploded view of a product information system, according to an example of the present disclosure.

FIG. 22 illustrates an isometric front view of the product information system of FIG. 21.

FIG. 23 illustrates a front view of the product information system of FIG. 21.

FIG. 24 illustrates a top view of the product information system of FIG. 21.

FIG. 25 illustrates a bottom view of the product information system of FIG. 21.

FIG. 26 illustrates a lateral view of the product information system of FIG. 21.

FIG. 27 illustrates an isometric exploded view of a securing assembly, according to an example of the present disclosure.

FIG. 28 illustrates an isometric view of the securing assembly having a communication device mounted on an insert mount, according to an example of the present disclosure.

FIG. 29 illustrates an isometric view of the securing assembly having the communication device mounted on the insert mount, which is disposed within a cavity of a stem of a suction cup, according to an example of the present disclosure.

FIG. 30 illustrates an isometric view of the securing assembly, according to an example of the present disclosure.

FIG. 31 illustrates an isometric exploded view of a securing assembly, according to an example of the present disclosure.

FIG. 32 illustrates an isometric view of the securing assembly having a communication device mounted on an insert mount, according to an example of the present disclosure.

FIG. 33 illustrates an isometric view of the securing assembly having the communication device mounted on the insert mount, which is disposed within a cavity of a stem of a suction cup, according to an example of the present disclosure.

FIG. 34 illustrates an isometric view of the securing assembly, according to an example of the present disclosure.

FIG. 35 illustrates an isometric view of a securing assembly having a suction cup separated from a suction securing nut, according to an example of the present disclosure.

FIG. 36 illustrates an isometric view of a securing assembly having a suction cup separated from a suction securing nut, according to an example of the present disclosure.

FIG. 37 illustrates an isometric rear view of a coupler, according to an example of the present disclosure.

FIG. 38 illustrates a rear view of the coupler of FIG. 37.

FIG. 39 illustrates a lateral view of the coupler of FIG. 37.

FIG. 40 illustrates a front view of the coupler of FIG. 37.

FIG. 41 illustrates an isometric front view of a product information system having a housing in a disconnected state, according to an example of the present disclosure.

FIG. 42 illustrates an isometric rear view of the product information system of FIG. 41 having the housing in the disconnected state.

FIG. 43 illustrates an isometric front view of the product information system of FIG. 41 having a card disconnected from the housing.

FIG. 44 illustrates an isometric front view of the product information system of FIG. 41 having the card coupled to the housing.

FIG. 45 illustrates an isometric rear view of the product information system of FIG. 42 having a rear portion of the housing disconnected from a front portion.

FIG. 46 illustrates an isometric front view of a product information system having a card disconnected from a housing, according to an example of the present disclosure.

FIG. 47 illustrates an isometric rear view of the housing of FIG. 46 secured to a stand, according to an example of the present disclosure.

FIG. 48 illustrates an isometric front view of a product information system having a card disconnected from a housing, according to an example of the present disclosure.

FIG. 49 illustrates an isometric rear view of the housing of FIG. 48 secured to a rail.

FIG. 50 illustrates an isometric front view of a product information system having a card disconnected from a housing, according to an example of the present disclosure.

FIG. 51 illustrates an isometric rear view of the housing of FIG. 50 secured to a retaining clip.

FIG. 52 illustrates an isometric front view of a product information system having a card disconnected from a housing, according to an example of the present disclosure.

FIG. 53 illustrates an isometric rear view of the housing of FIG. 52.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide product information systems and methods. The systems and methods include a housing, and a communication device coupled to the housing. The communication device can be a near field communication tag. The communication device can be contained on or within a card, and thereby provide a smart card.

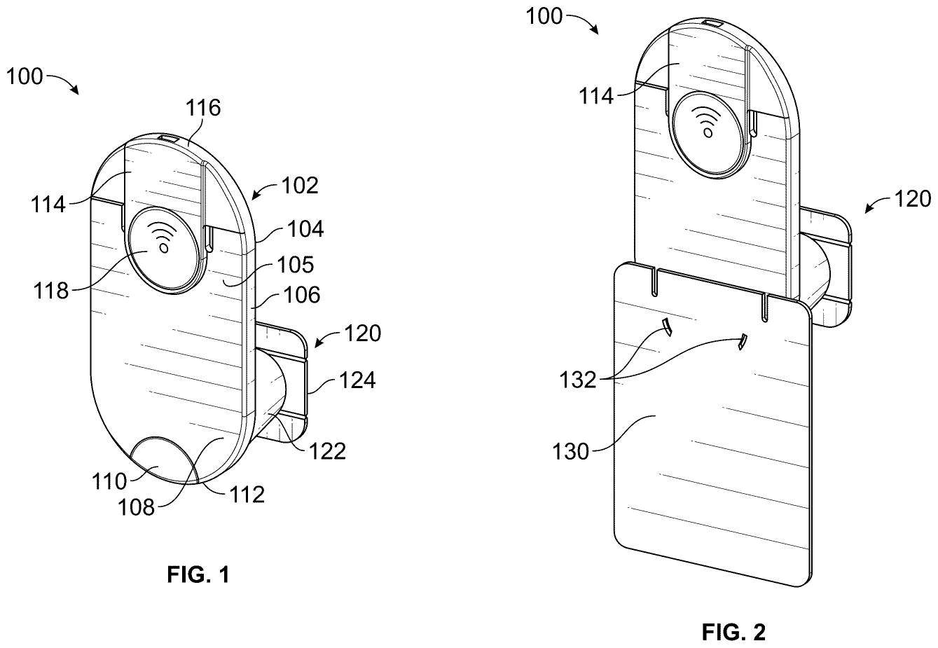

FIG. 1 illustrates a front isometric view of a product information system 100, according to an example of the present disclosure. The product information system 100 includes a housing 102, which can include a rear panel 104 secured to a front panel 105. Optionally, the housing 102 can include a single, unitary panel. The housing 102 includes a base 106, which can include a flat, planar surface 108. The base 106 can be a front surface of the front panel 105, for example. A bottom ledge 110 of the rear panel 104 extends from a lower edge 112. The bottom ledge 110 is configured to snapably secure to a reciprocal recess of the front panel 105.

An upper clip 114 extends downwardly from an upper edge 116 of the housing 102 over an upper portion of the surface 108. The upper clip 114 is separated from the surface 108 by a gap. The upper clip 114 includes a tap indicia 118. The tap indicia 118 is an area where an individual can tap a smart device (such as a smart phone, tablet, or the like) to receive information regarding a product, as described herein. The tap indicia 118 provides a graphic, text, and/or the like that indicates where an individual should move a handheld smart device (for example, by tapping, waving, or otherwise moving in close proximity, such as within 10 centimeters or less) to receive information regarding product(s).

The product information system 100 also includes a securing assembly 120 coupled to the housing 102. In at least one example, the housing 102 forms at least a part of the securing assembly 120. In at least one example, the securing assembly 120 includes a moveable joint 122 that moveably couples the housing 102 to a mount 124. As an example, the joint 122 can be a ball and socket joint. As another example, the joint 122 can be an articulating arm. As another example, the joint 122 can be a fixed, non-movable connection.

FIG. 2 illustrates a front isometric view of the product information system 100 receiving a card 130, according to an example of the present disclosure. Referring to FIGS. 1 and 2, the card 130 can be a planar sheet that is configured to be retained on the base 106 by the upper clip 114. As shown, the card 130 can include a plurality of defined slots 132 that are configured to receive and retain reciprocal protrusions (such as tabs, barbs, nubs, posts, and/or the like) extending from a lower surface of the upper clip 114 to secure the card 130 in a stable position.

In at least one example, the card 130 can include graphics, texts, and/or the like that provides information for a product. For example, the card 130 can include an advertisement for a product. The card 130 can include a communication device, such as a near field communication chip, as described herein. In this manner, the card 130 can be a smart card. Optionally, the card 130 may not include a communication device. Instead, a communication device can be separately secured to the housing 102, for example.

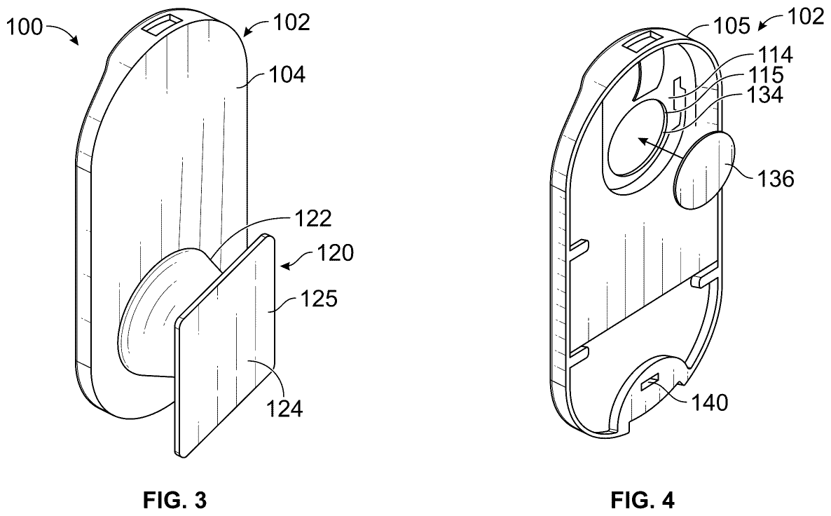

FIG. 3 illustrates a rear isometric view of the product information system 100, according to an example of the present disclosure. In at least one example, the mount 124 includes a flexible layer 125 of nanotechnology gel, which is configured to secure the product information system 100 to a surface. For example, the mount 124 is configured to removably secure to a front surface of a door of a refrigerated compartment. As another example, the mount 124 can removably secure to a surface of a wall, a table, a countertop, a desk, and/or the like. Instead of the flexible layer 125 of nanotechnology gel, the mount 124 can be or otherwise include a suction cup assembly. As another example, the mount 124 can include the suction cup assembly having a flexible layer of nanotechnology gel.

FIG. 4 illustrates a rear isometric view of the front panel 105 of the housing 102, according to an example of the present disclosure. A rear surface of the clip 114 can include an area 134 that is configured to receive and retain a communication device 136, such as a chip, radio frequency identification (RFID) tag, and/or the like. In at least one example, the communication device 136 is a near field communication (NFC) chip decal that is configured to couple to the rear surface 115 of the clip 114. The communication device 136 can be directly secured to the area 134. As another example, the communication device 136 is retained on and/or within the card 130, as described herein.

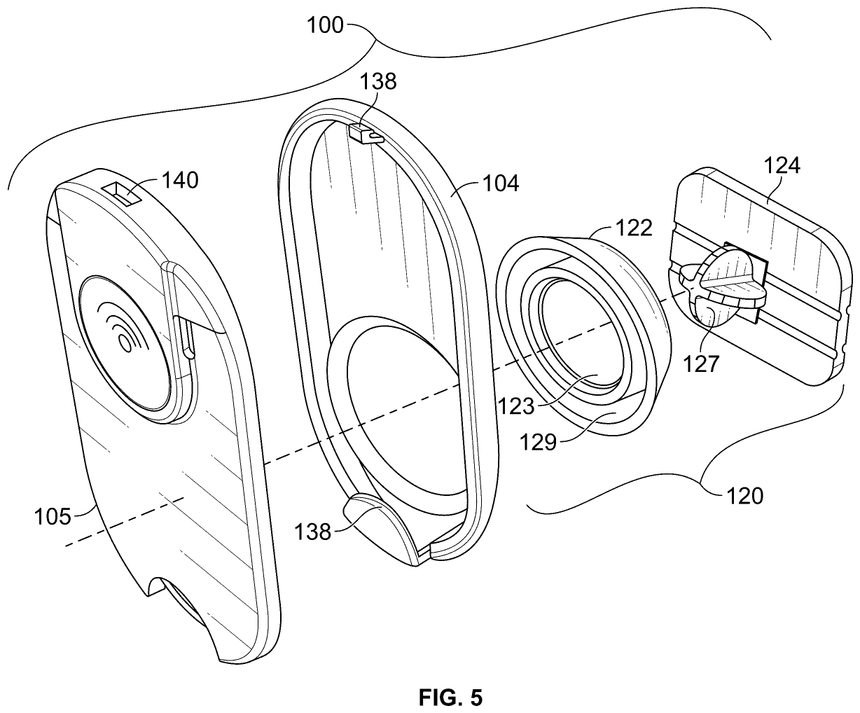

FIG. 5 illustrates a front isometric exploded view of the product information system 100. As shown, the front panel 105 can snapably secure to the rear panel 104, such as through one or more deflectable tabs 138 that secure into reciprocal slots 140. A ball 127 extending from a front surface of the mount 124 can be moveably retained within a reciprocal bearing 123 of the joint 122. The joint 122 can include a cap 129 surrounding the bearing 123. The cap 129 can be configured to threadably secured to a reciprocal structure on a rear surface of the rear panel 104.

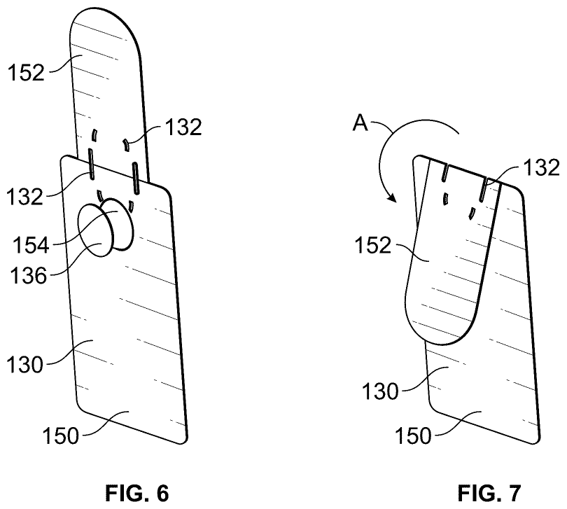

FIG. 6 illustrates a front view of the card 130 and the communication device 136, according to an example of the present disclosure. As shown, the card 130 can include a base sheet 150 and a retainer sheet 152 extending upwardly from the base sheet 150. The slots 132 provide openings sized and shaped to align with protrusions (such as tabs) of the clip 114 (shown in FIGS. 1 and 2, for example). The communication device 136, such as an NFC chip decal, is secured to a defined location 154 on the card 130. The defined location 154 is configured to be underneath the tap indicia 118 (shown in FIG. 1, for example) by way of the protrusions being retained by overlapping slots 132.

FIG. 7 illustrates a front view of the card 130 securing the communication device 136, according to an example of the present disclosure. As described herein, the communication device 136 can be retained within folded portions of the card 130. For example, referring to FIGS. 6 and 7, the retainer sheet 152 is folded over the base sheet 150 to securely sandwich the communication device 136 therebetween. After the retainer sheet 152 is folded over the base sheet 150, the slots 132 of each are aligned, and configured to retain protrusions of the clip 114. Optionally, the card 130 may not be configured to have foldable portions. Instead, the communication device 136 can be configured to adhered to a surface of the card 130 without any portions being folded over to secure the communication device 136 in place.

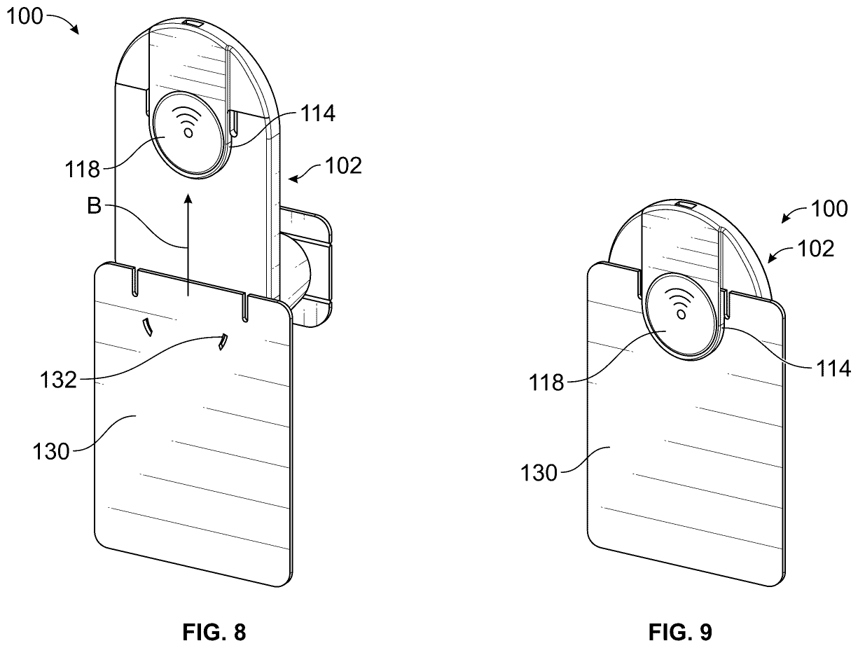

FIG. 8 illustrates a front isometric view of the card 130 being coupled to the housing 102 of the product information system 100, according to an example of the present disclosure. Referring to FIGS. 6-8, the card 130 includes the communication device 136. The card 130 is then inserted upwardly in the direction of arrow B so that the slots 132 engage the protrusions of the clip 114, thereby securing the card 130 to the housing 102. The card 130 is disposed behind the tap indicia 118.

FIG. 9 illustrates a front isometric view of the product information system 100 having the card 130, according to an example of the present disclosure. As shown, the card 130 may be secured to the housing 102 by the clip 114, and may extend below a lower edge of the housing 102.

Referring to FIGS. 1-9, the card 130 having the communication device 136 provides a smart card. The communication device 136 is configured to provide product information in response to an individual placing a smart device in proximity to the tap indicia 118.

The product information system 100 can be used in conjunction with a product holder system. As another example, the product information system 100 can be separate from a product holder system.

The communication device 136 can include a control unit, one or more processors, and/or the like. For example, the communication device 136 device can be a near field communication (NFC) tag. As another example, the communication device 136 can be a radio frequency identification (RFID) tag. The communication device can be on or within the card 130. As another example, the card 130 itself is or otherwise provides the communication device.

In operation, an individual positions a handheld device, such as a smart phone, tablet, or the like, in close proximity (such within 10 centimeters or less, and/or by tapping with the handheld device) to the tap indicia 118. In response, the communication device 136 one or both of outputs information to the handheld device (such as information regarding a product, service, advertisement, promotion, and/or the like), and/or automatically directs the handheld device to an information source (such as a website) that provides the information.

As described herein, the product information system 100 includes the housing 102, which retains the card 130, and can attach to multiple display locations in retail environments. The card 130 having the communication device 136 is configured to provide near field communication (NFC) to mobile phones and devices at the point of display while shoppers are in the process of shopping. NFC chips can be attached to the housing 102 directly, or attached to or embedded within the card 130, which are inserted into and/or onto the housing 102.

When individuals place a smart device (such as a mobile smart phone) within ˜1 inch of a noted tap location (for example, the tap indicia 118) identified on the holder, the smart device recognizes the communication device 136, such as an NFC chip, which triggers the smart device to connect to a URL address programmed into the NFC chip.

The housing 102 having the clip 114 can be used either by itself or attached to the securing assembly 120. The clip 114 allows different cards to be selectively inserted, and locked in place. The communication device 136 can be either directly applied to the clip 114 or to the card 130 depending on a desired usage.

In at least one example, the securing assembly 120 includes a housing connected to a ball and socket-type mount. The ball and socket mount allows the device to be rotated and located into multiple positions as needed to face the shopper in the most optimal position. Optionally, the securing assembly can include a suction cup. As another example, the securing assembly may not include a ball and socket.

In at least one example, the securing assembly 120 can include a suction cup that couples to a suction securing nut (or knob) and/or a securing mount, which can be integrally formed with a bracket, as described in U.S. Pat. No. 10,104,986, entitled “Systems and Methods for Securing and Displaying Products,” which is hereby incorporated by reference in its entirety. Optionally, the securing assembly 120 can include locking rings, or other such features that separately couple to the bracket. As another example, the securing assembly 120 can be configured as described in U.S. Pat. No. 10,393,168, entitled “Securing Assembly,” which is hereby incorporated by reference in its entirety. As another example, the securing assembly 120 can include a suction cup permanently secured to a bracket. For example, a suction cup can extend from a portion of the bracket. In at least one other example, instead of a suction cup, the securing assembly 120 can includes a flange or other such structure coated with a nanotechnology gel, which is similar to an adhesive, but can be removed and reused.

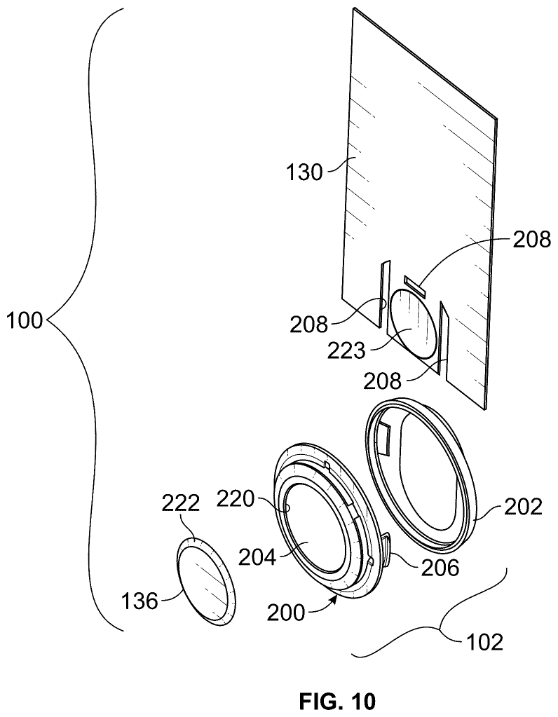

FIG. 10 illustrates a front isometric exploded view of a product information system 100, according to an example of the present disclosure. In this example, the housing 102 includes a front ring 200 and a rear ring 202. The front ring 200 is configured to snapably secure to the rear ring 202. A central passage 204 is formed through the front ring 200.

The communication device 136 is configured to be aligned (such as substantially axially aligned-for example, within +/−5 degrees) with the central passage 204. For example, the communication device 136 can be secured to the card 130 within the central passage 204. As another example, the communication device 136 can be retained within the central passage 204 between the front ring 200 and the rear ring 202 without a separate card.

The front ring 200 includes protrusions 206, such as fins, tabs, or the like, that are configured to be retained within reciprocal openings 208 of the card 130. The communication device 136 can include the tap indicia, and is retained on the card 130 by the housing 102. For example, an interior rim 220 of the front ring 200 may sandwich an outer rim 222 of the communication device 136 against a front surface of the card 130. Optionally, the communication device 136 can be adhesively secured to an area 223 of the card 130, and the front ring 200 and the rear ring 202 can then be snapably secured together and positioned on the card 130.

The card 130 can be folded over itself to securely contain the communication device 136 between folded portions. Optionally, the card 130 may not be configured to fold over a portion of the communication device 136. Instead, the communication device 136 can be secured to the area 223, either directly, and/or by the housing 102.

As shown, the product information system 100 may not include a separate securing assembly. Instead, the rear ring 202 may include a coupler, such as a nanotechnology gel. As another example, the card 130 can include a strap, wire, string, or the like that is configured to allow the product information system 100 to hang from a hook, for example, As another example, the card 130 can include a coupler, such as a nanotechnology gel. As another example, the housing 102 may be configured to be retained by a stand.

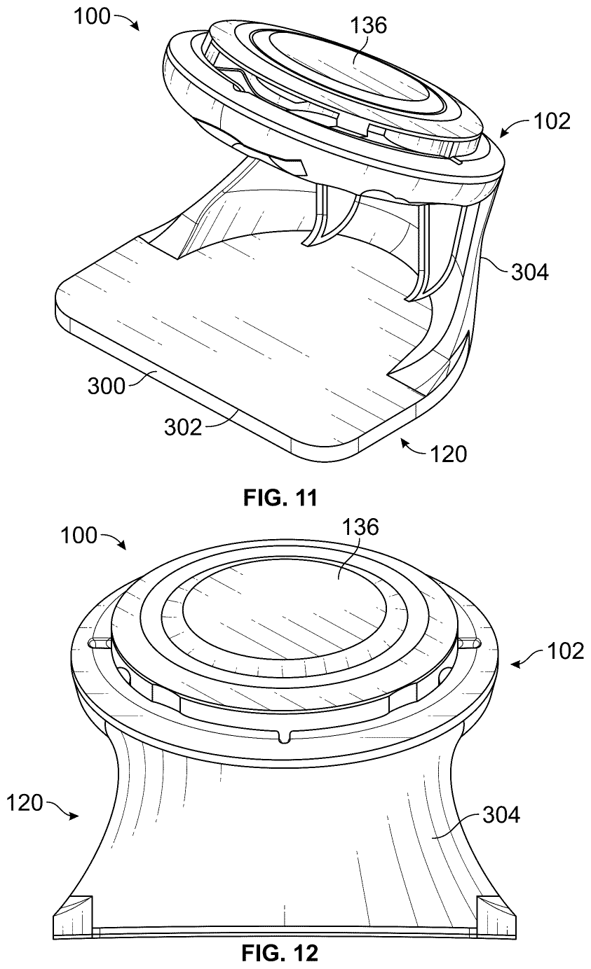

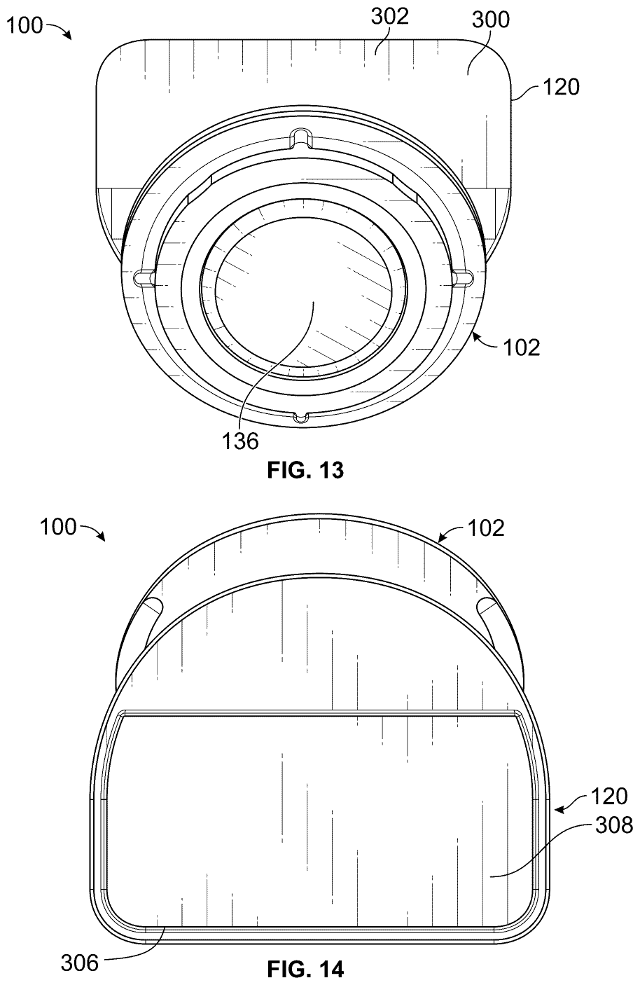

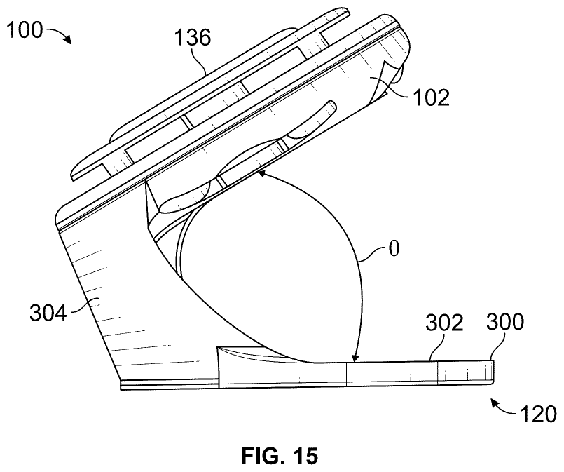

FIG. 11 illustrates an isometric view of a product information system 100, according to an example of the present disclosure. FIG. 12 illustrate a front view of the product information system 100 of FIG. 11. FIG. 13 illustrates a top view of the product information system 100 of FIG. 11. FIG. 14 illustrates a bottom view of the product information system 100 of FIG. 11. FIG. 15 illustrates a lateral view of the product information system 100 of FIG. 11.

Referring to FIGS. 11-15, the communication device 136 can be retained by the housing 102, such as any of those described herein, without a separate card. Optionally, the communication device 136 can be secured to the card, which can then be secured to the housing 102, as shown and described herein. Further, the housing 102 is secured to a securing assembly 120, which can be a stand 300. The stand 300 includes a base 302 that is configured to be supported on a surface, such as a countertop, table, desk, or the like. An extension wall 304 outwardly extends from the base 302 to outwardly extend the communication device 136. The extension wall 304 can be angled to set the housing 102 and the communication device 136 retained by the housing 102 as an angle θ with respect to the base 302. A bottom surface 306 can include a nanotechnology gel 308, as described herein.

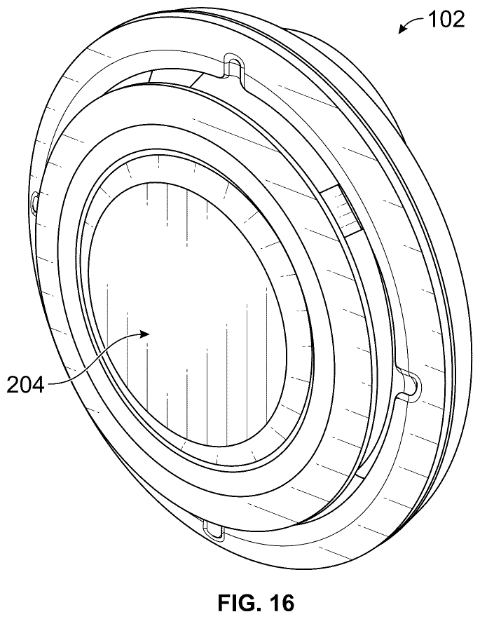

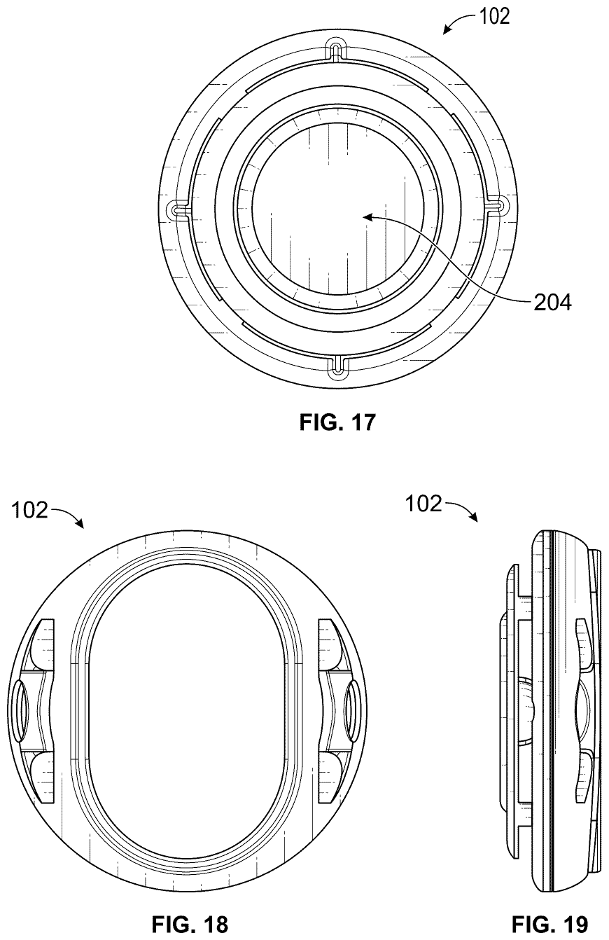

FIG. 16 illustrates an isometric front view of a housing 102, according to an example of the present disclosure. FIG. 17 illustrates a front view of the housing 102 of FIG. 16. FIG. 18 illustrates a rear view of the housing 102 of FIG. 16. FIG. 19 illustrates a lateral view of the housing 102 of FIG. 16.

Referring to FIGS. 16-19, the housing 102 can be used to securely retain a communication device. The housing 102 can be used with any of the examples shown and described herein. The housing 102 can be coupled to a securing assembly. Optionally, the housing 102 can be used without a securing assembly. The housing 102 can retain a communication device by itself, or in conjunction with a card, as described herein.

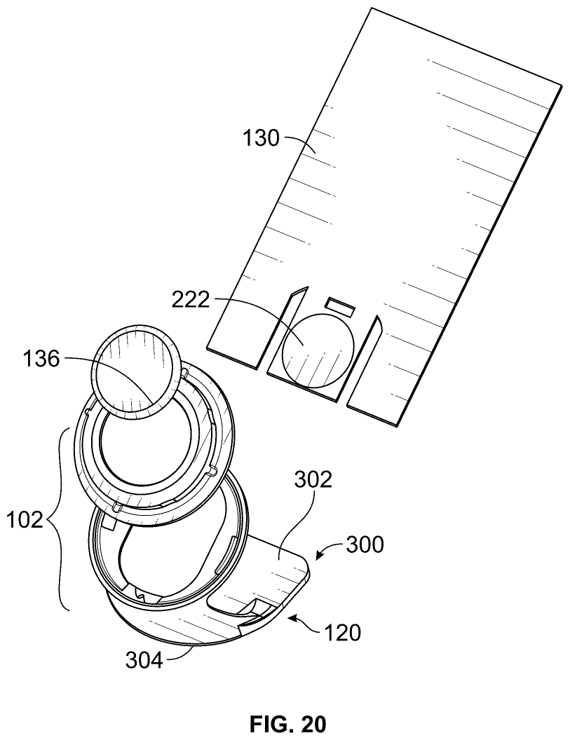

FIG. 20 illustrates an isometric exploded view of a product information system 100, according to an example of the present disclosure. Referring to FIGS. 11-20, the communication device 136 can be secured to the area 223 of the card 130. The housing 102 retains the card 130. The stand 300 supports the card 130 and the communication device 136 in an upward position, such as when the stand 300 is supported on a surface.

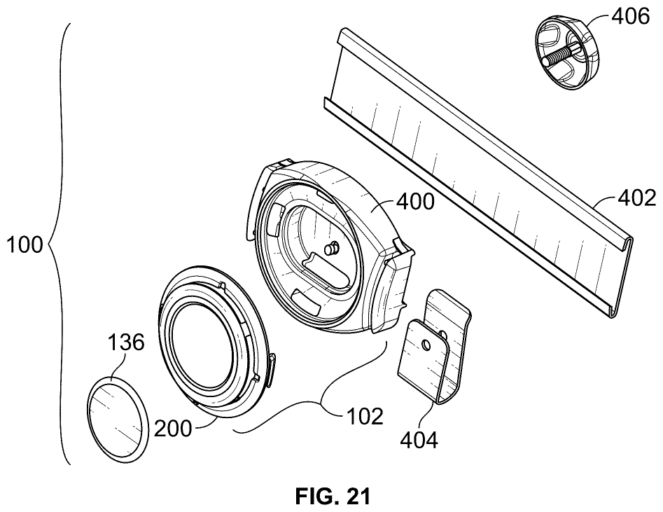

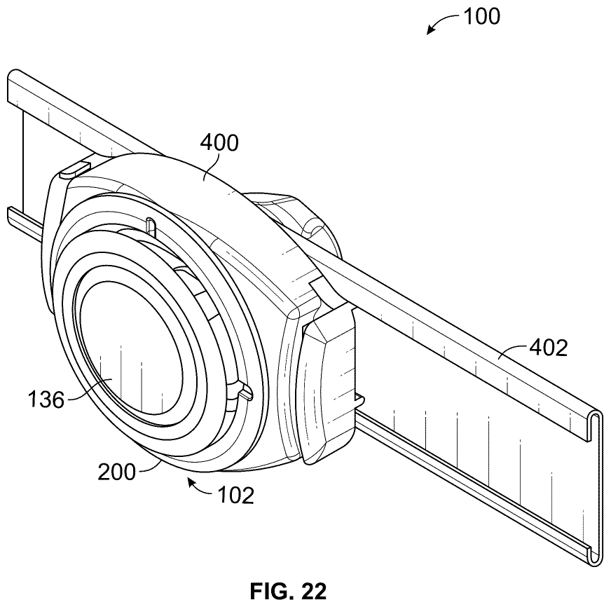

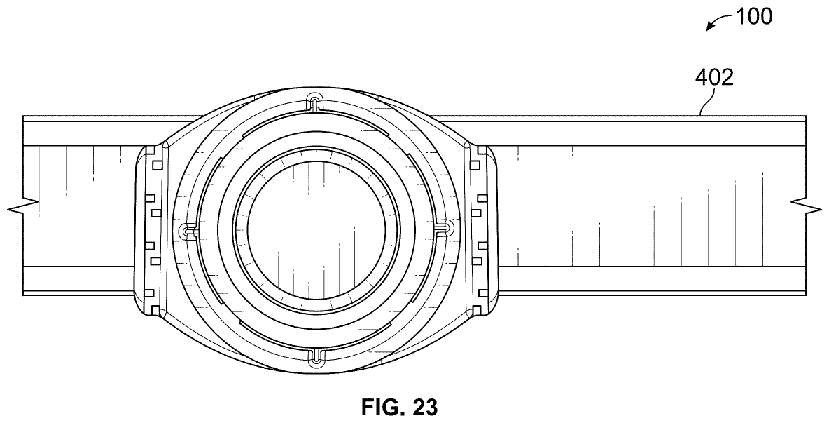

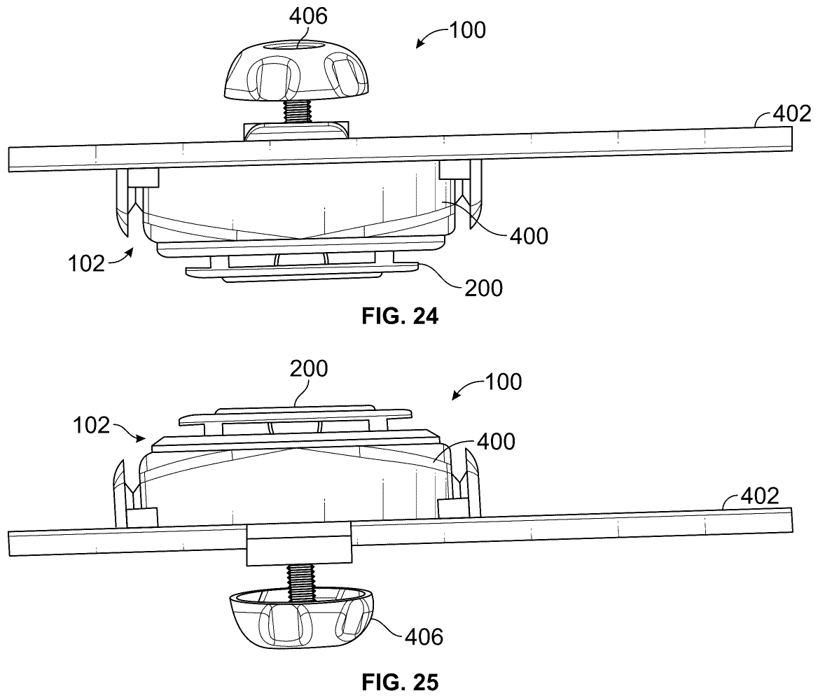

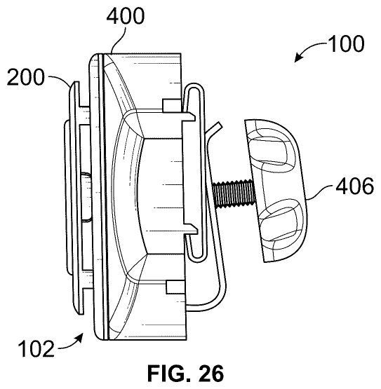

FIG. 21 illustrates an isometric exploded view of a product information system 100, according to an example of the present disclosure. FIG. 22 illustrates an isometric front view of the product information system 100 of FIG. 21. FIG. 23 illustrates a front view of the product information system 100 of FIG. 21. FIG. 24 illustrates a top view of the product information system 100 of FIG. 21. FIG. 25 illustrates a bottom view of the product information system 100 of FIG. 21. FIG. 26 illustrates a lateral view of the product information system 100 of FIG. 21.

Referring to FIGS. 21-26, the housing 102 can include the front ring 200 secured to a rear retainer 400 that is configured to clip to a rail 402 by a retaining clip 404 and a tap screw 406. The rail 402 can be a bracket, beam, or the like. In at least one example, the rail 402 is a price sign holder. In this example, the securing assembly 120 includes the retaining clip 404 and the tap screw 406, which are configured to secure the housing 102 to the rail 402. In this example, the product information system 100 may not include a card. Optionally, the product information system 100 may include a card.

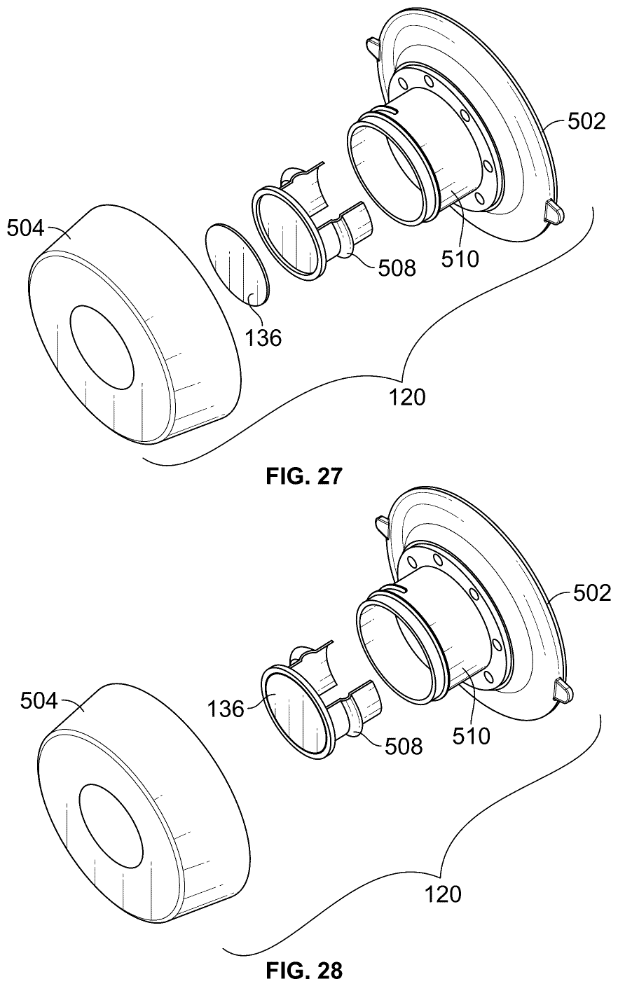

FIG. 27 illustrates an isometric exploded view of a securing assembly 120, according to an example of the present disclosure. FIG. 28 illustrates an isometric view of the securing assembly 120 having a communication device 136 mounted on an insert mount 508, according to an example of the present disclosure.

The securing assembly 120 can be used with respect to any of the examples of the present disclosure. For example, the securing assembly 120 shown in FIGS. 27 and 28 can be used in place of the securing assembly 120 shown in FIGS. 1-3.

Referring to FIGS. 27 and 28, the securing assembly 120 can include a suction cup 502 that couples to a suction securing nut 504 (or knob) and/or a securing mount, which can be integrally formed with a bracket, as described in U.S. Pat. No. 10,104,986, entitled “Systems and Methods for Securing and Displaying Products.” Optionally, the securing assembly 120 can include locking rings, or other such features that separately couple to the bracket. As another example, the securing assembly 120 can be configured as described in U.S. Pat. No. 10,393,168, entitled “Securing Assembly.” As another example, the securing assembly 120 can include a suction cup permanently secured to a bracket. For example, a suction cup can extend from a portion of the bracket. In at least one other example, instead of a suction cup, the securing assembly 120 can include a flange or other such structure coated with a nanotechnology gel, which is similar to an adhesive, but can be removed and reused.

In at least one example, the securing assembly 120 includes the communication device 136, which can be disposed between and within one or both of the suction cup 502 and the suction securing nut 504. As noted, the communication device 136 can be a near field communication tag or chip, an RFID tag or chip, and/or the like. In at least one example, the securing assembly 120 also includes the insert mount or capsule 508 that is configured to fit within and/or around a stem 510 of the suction cup 502. In at least one example, the communication device 136 mounts on the insert mount 508.

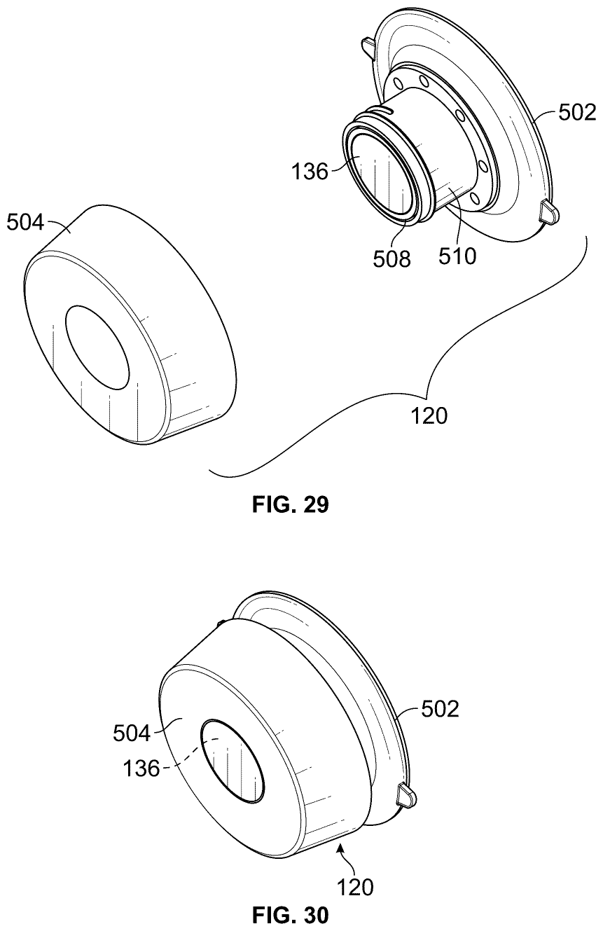

FIG. 29 illustrates an isometric view of the securing assembly 120 having the communication device 136 mounted on the insert mount 508, which is disposed within a cavity of the stem 510 of the suction cup 502. FIG. 30 illustrates an isometric view of the securing assembly 120. As shown in FIG. 30, the suction securing nut 504 couples to the suction cup 502, such as via rotational threadable engagement. As shown in FIGS. 27-30, the communication device 136 is within the securing assembly 120 at a distal end of the stem 510 of the suction cup 502 proximate to an end of the suction securing nut 504.

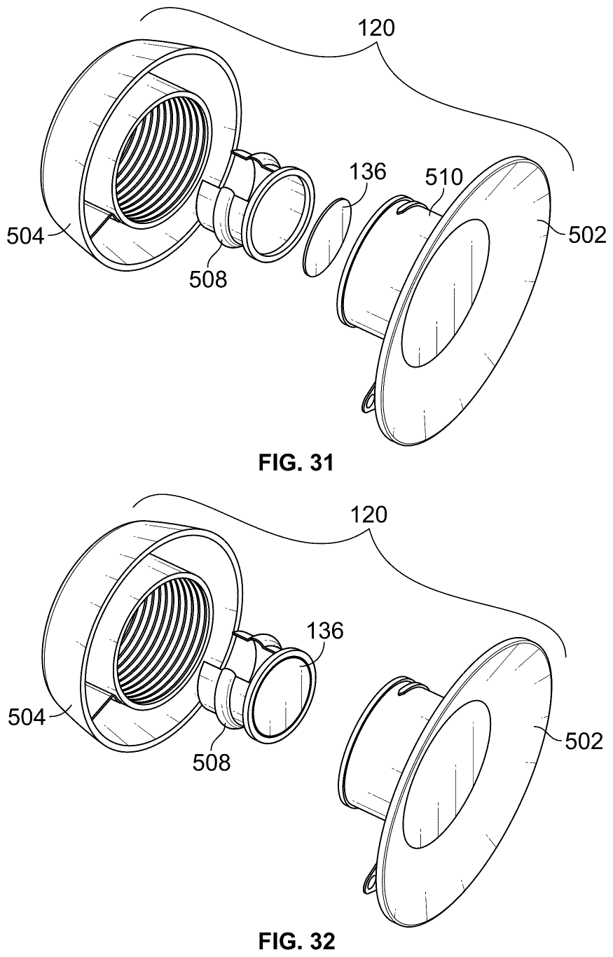

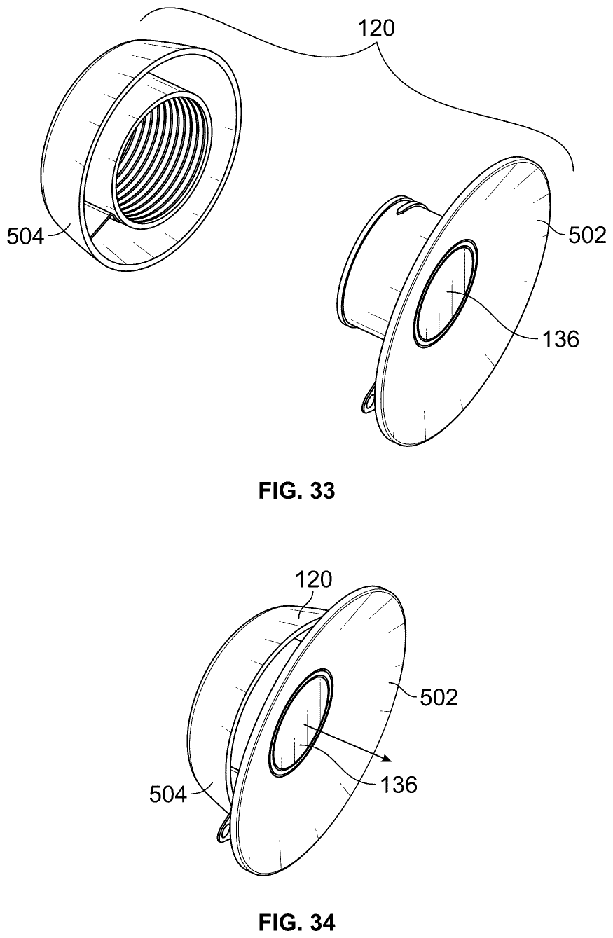

FIG. 31 illustrates an isometric exploded view of a securing assembly 120, according to an example of the present disclosure. FIG. 32 illustrates an isometric view of the securing assembly 120 having the communication device 136 mounted on the insert mount 508. FIG. 33 illustrates an isometric view of the securing assembly 120 having the communication device 136 mounted on the insert mount 508, which is disposed within a cavity of the stem 510 of the suction cup 502. FIG. 34 illustrates an isometric view of the securing assembly 120. As shown in FIGS. 31-34, the communication device 136 can be disposed within the cavity of the stem 510 proximate to a base of the suction cup 502. The securing assembly 120 shown and described with respect to FIGS. 31-34 can be used with any of the examples of the present disclosure described herein.

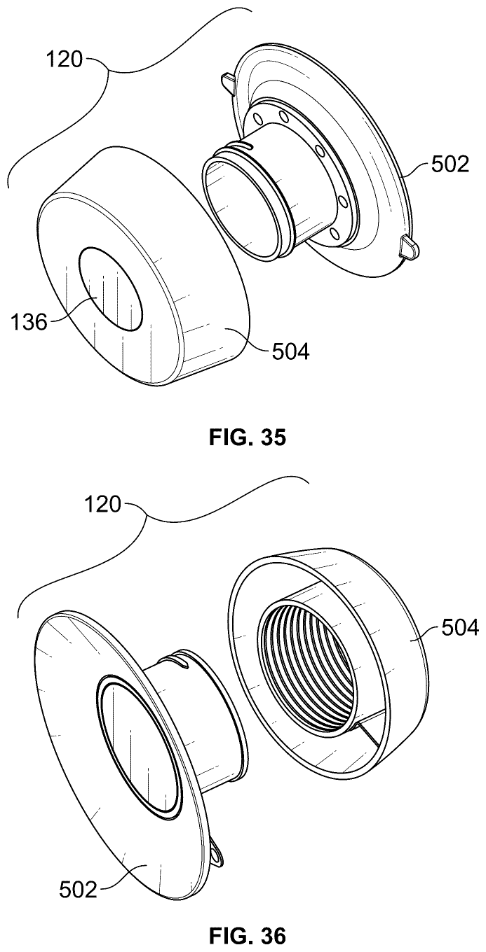

FIG. 35 illustrates an isometric view of the securing assembly 120 having the suction cup 502 separated from the suction securing nut 504, according to an example of the present disclosure. As shown in FIG. 35, the communication device 136 can be secured to the suction securing nut 504. For example, the communication device 136 can be secured to an outer surface of the suction securing nut 504, whether directly, or indirectly through an intermediate coupling mount. Optionally, the communication device 136 can be secured to an interior surface of the suction securing nut 504. The securing assembly 120 shown and described with respect to FIG. 35 can be used with any of the examples of the present disclosure described herein.

FIG. 36 illustrates an isometric view of the securing assembly 120 having the suction cup 502 separated from the suction securing nut 504, according to an example of the present disclosure. As shown in FIG. 36, the communication device 136 can be secured to the suction cup 502. For example, the communication device 136 can be secured to an outer surface of the suction cup 502, whether directly, or indirectly through an intermediate coupling mount. Optionally, the communication device 136 can be secured to an interior surface of the suction cup 502. The securing assembly 120 shown and described with respect to FIG. 36 can be used with any of the examples of the present disclosure described herein.

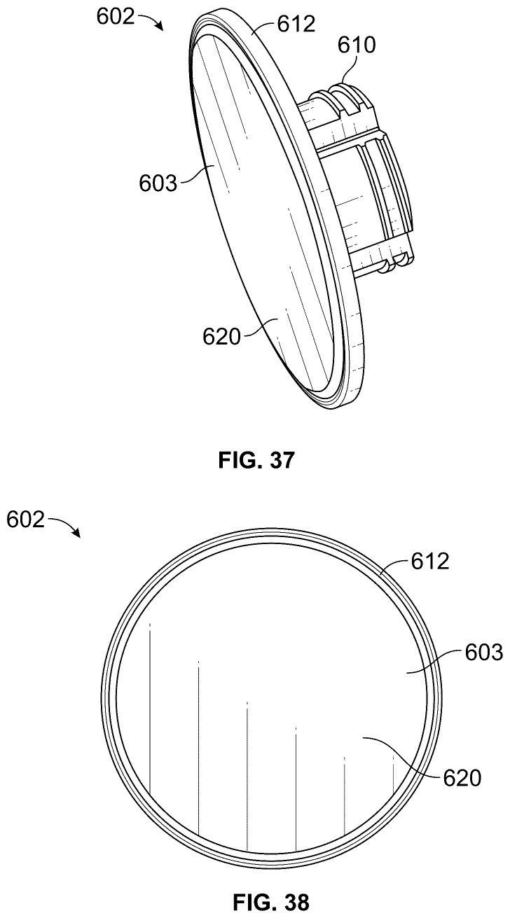

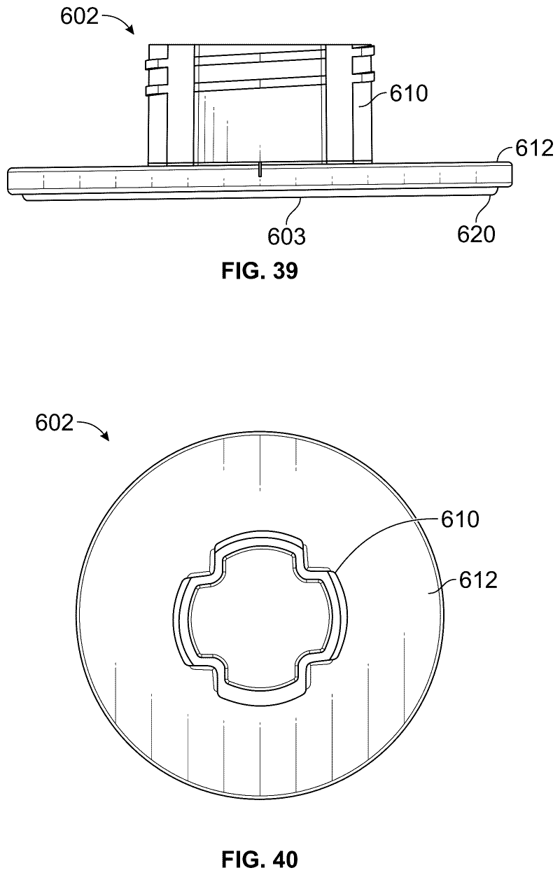

FIG. 37 illustrates an isometric rear view of a coupler 602, according to an example of the present disclosure. FIG. 38 illustrates a rear view of the coupler 602 of FIG. 37. FIG. 39 illustrates a lateral view of the coupler 602 of FIG. 37. FIG. 40 illustrates a front view of the coupler 602 of FIG. 37.

Referring to FIGS. 37-40, the coupler 602 includes a stem 610 extending from a base 612. As shown, the base 612 can be a circular disk. The stem 610 can be coaxially aligned with the base 612.

In at least one example, the coupler 602 is used with the securing assembly 120 shown and described with respect to FIGS. 27-36. In particular, in at least one example, the coupler 602 can be used in place of the suction cup 602. As noted above, instead of a suction cup, the securing assembly 120 can include a flange or other such structure coated with a nanotechnology gel 620, which is similar to an adhesive, but can be removed and reused. The coupler 602 can be used with the securing assembly 120, or various other brackets, devices, assemblies, and the like.

The coupler 602 further includes a coupling layer 603 extending from a rear surface of the base 612. The coupling layer 603 can be a film, coating, adhesive panel, and/or the like. In at least one example, the coupling layer 603 is formed of a nanotechnology gel. The coupling layer 603 can be removable from the base 612. Optionally, the coupling layer 603 can be permanently secured to the base 612. The coupling layer 603 is configured to adhere to a surface, such as a glass panel. As such, the coupler 602 is used to secure the securing assembly 120 to a structure, such as a glass door, for example.

In at least one example, the stem 610 and the base 612 can be formed of a polymer. In at least one example, the stem 610 and the base 612 can be formed of polycarbonate. In at least one example, the coupling layer 603 is formed of a polyurethane adhesive, which is configured to secure the coupler 602 to a structure. As such, the coupler 602 can be used in place of the suction cup 602 to removably secure the securing assembly 120 to a structure.

In at least one other example, the coupling layer 603 is applied to a suction cup, such as the suction cup 502. That is, a surface of the suction cup that is configured to engage a surface of a component (such as a glass door of a refrigerated or freezer compartment) includes the coupling layer 603. For example, the coupling layer 603 can coat the surface of the suction cup. As another example, the coupling layer 603 can be applied over at least a portion of the surface of the suction cup. In at least one other example, the coupling layer 603 can be applied over an entirety of the suction cup.

In at least one example, a securing assembly 120, such as any of the described herein, includes a layer of nanogel coupled to a suction cup. The securing assembly having the nanogel (such as a layer of nanogel that coats a rear surface of the suction cup) can then be mounted on a surface of a component, such as a glass panel of a door of a freezer or a refrigerated compartment. The surface of the component can first be cleaned with an alcohol wipe, for example. It has been found that the nanogel layer combats condensation that can form on freezer doors (a suction cup without such nanogel layer is less likely to combat such condensation).

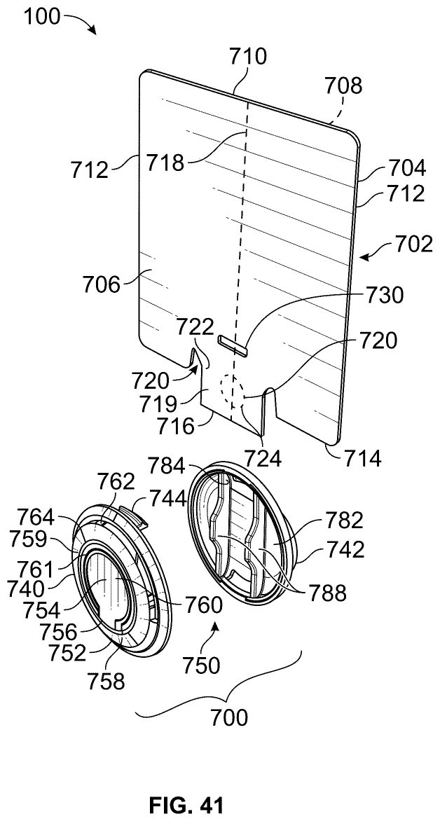

FIG. 41 illustrates an isometric front view of a product information system 100 having a housing 700 in a disconnected state, according to an example of the present disclosure. The housing 700 is configured to retain a card 702, as described herein. In at least one example, the housing 700 is, or otherwise provides, a clip, configured to securely retain the card 702. In at least one example, the card 702 can be formed of Styrene. As another example, the card 702 can be formed of Styrofoam. As another example, the card 702 can be formed of cardboard. As another example, the card 702 can be formed of reinforced paper. As another example, the card 702 can be formed of plastic.

The card 702 includes a main panel 704, which can be rectangular in shape. Optionally, the main panel 704 can be sized and sized differently than shown. For example, the main panel 704 can be circular, triangular, irregularly-shaped, or the like. The main panel 704 can include text, graphics, and/or the like, which provide information regarding a product, for example. The main panel 704 includes a front face 706 connected to an opposite rear face 708. The main panel 704 includes a top edge 710 connected to lateral edges 712 and a bottom edge 714. An insertion beam 716 downwardly extends from the bottom edge 714. As shown, the insertion beam 716 can be generally aligned with a central vertical axis 718 of the card 702. Notches 720 may extend upwardly from the bottom edge 714 on both sides of a root 722 of the insertion beam 716. Optionally, the card 702 may not include the notches.

A communication device 722 is retained by the insertion beam 716. As described herein, in at least one example, the communication device 722 is a near field communication chip. In this manner, the card 702 can be a smart card.

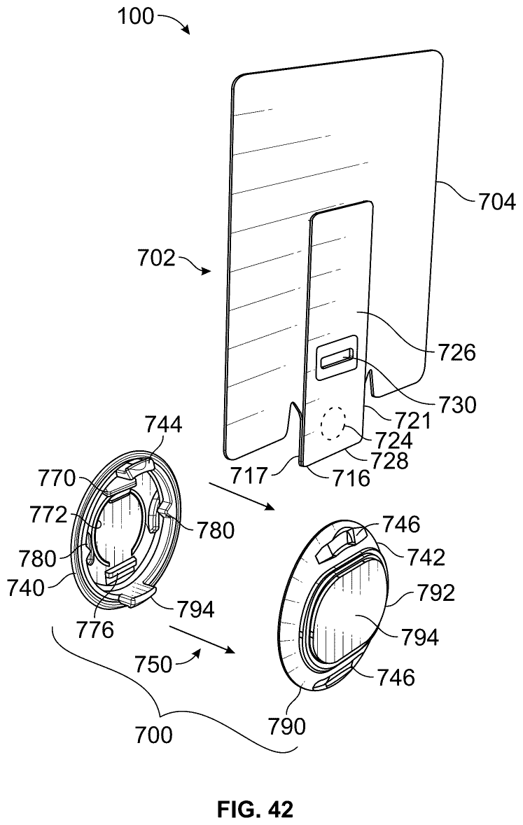

FIG. 42 illustrates an isometric rear view of the product information system 100 of FIG. 41 having the clip in the disconnected state. Referring to FIGS. 41 and 42, the insertion beam 716 can be formed by a lower portion 717 of an extension beam 726 that is folded about a fold line 728, which formed a lower edge of the insertion beam 716. In at least one example, the communication device 722 is retained between a front surface 719, a rear surface 721, and the fold line 728. As such, the communication device 722 can be retained within a folded portion of the insertion beam 716. Optionally, the insertion beam 716 may not include a folded portion, and the communication device 722 can be embedded within insertion beam 716. As another example, the communication device 722 can be retained within other portions of the card 702, such as the main panel 704.

A slot 730 is formed through the card 702. For example, the slot 730 is formed through a lower portion of the main panel 704 above the insertion beam 716. Optionally, the slot 730 can be formed in the insertion beam 716, such as above the communication device 724. The extension beam 726 includes a slot that aligns with the slot 730 when folded over, as shown in FIG. 42. Optionally, the extension beam 726 when folded over may not extend to the slot 730.

The housing 700 includes a front portion 740 that removably connects to a rear portion 742. The front portion 740 is configured to secure to the rear portion 742 through one or more detents 744 (for example, snap tabs having deflectable arms), which mate with reciprocal coupling members 746 (for example, reciprocal slots) of the rear portion 742. Optionally, the front portion 740 can include the coupling members 746, and the rear portion 742 can include the detents 744. In at least one other example, the housing 700 is formed as a single, monolithic clip, instead of two connectable portions.

The front portion 740 and the rear portion 742 connect together to define an interior chamber 750 therebetween. As shown, the housing 700 can be disk shaped. Optionally, the housing 700 can be shaped differently, such as a box.

The front portion 740 includes a front outer surface 752. The front portion 740 further includes a button 754 including a stem 756 resiliently coupled to a lower portion 758 of a ring 759. A circular body 760 upwardly extends from the stem 756, and is separated from the ring 759 by a semicircular gap 761. Tap indicia can be disposed on a front surface of the circular body 760. An insertion channel 762 is formed through an upper portion 764 of the ring 759. The insertion channel 762 leads into (for example, is an opening of) the interior chamber 750 defined between the front portion 740 and the rear portion 742 (when connected together, for example).

A tab 770 inwardly extends from a front inner surface 772 of the front portion 740 into the interior chamber 750. The tab 770 is above the button 754. A lower stop 776 inwardly extends from the front inner surface 772 into the interior chamber 750. The lower stop 776 is below the button 754. Lateral guide protuberances 780 can also inwardly extend from the inner surface 772 on opposite sides of the button 754.

The rear portion 742 includes a rear inner surface 782. Guide fins 784 inwardly extend from the rear inner surface 782 into the interior chamber 750. As shown, the rear portion 742 can include two parallel guide fins 784. Optionally, the rear portion 742 can include one guide fin 784, or three or more guide fins 784. The guide fins 784 include a ramped protuberance 788, which provides a bump that further extends into the interior chamber 750.

The rear portion 742 also includes a rear outer surface 790. The rear outer surface 790 includes a coupler 792, which is configured to secure the housing 700 to a surface of a component, as described herein. In at least one example, the coupler 792 includes a flexible layer 794 of nanotechnology gel, which is configured to secure the product information system 100 to a surface. For example, the coupler 792 is configured to removably secure to a front surface of a door of a refrigerated compartment. As another example, the coupler 792 can removably secure to a surface of a wall, a table, a countertop, a desk, and/or the like. Instead of the flexible layer 794 of nanotechnology gel, the coupler 792 can be or otherwise include a suction cup assembly. As another example, the coupler 792 can include the suction cup assembly having a flexible layer of nanotechnology gel.

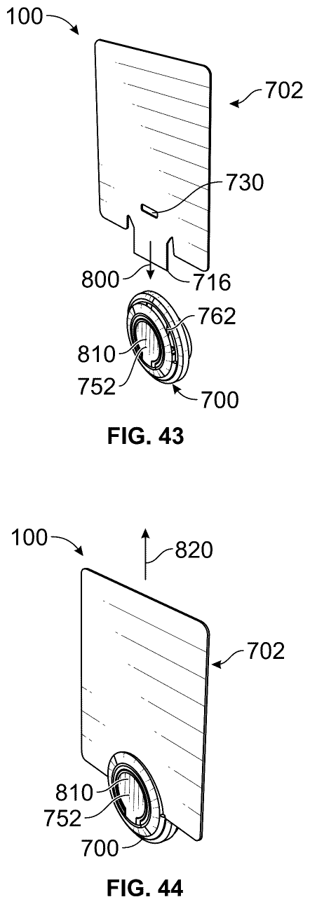

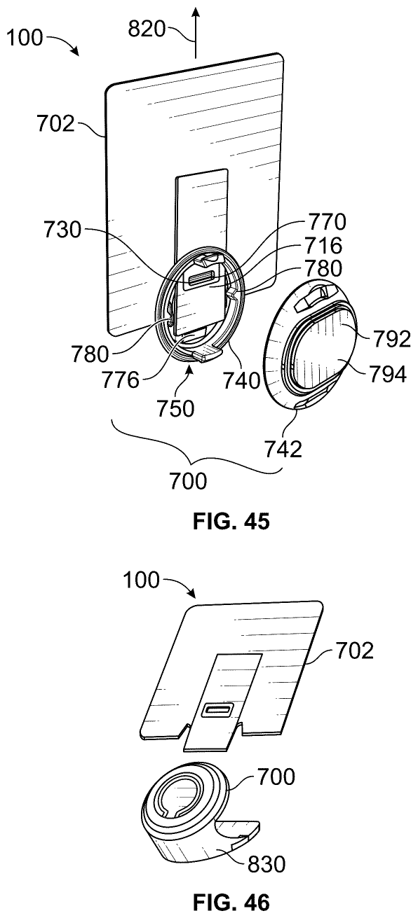

FIG. 43 illustrates an isometric front view of the product information system 100 of FIG. 41 having the card 702 disconnected from the housing 700. FIG. 44 illustrates an isometric front view of the product information system 100 of FIG. 41 having the card 702 coupled to the housing 700. FIG. 45 illustrates an isometric rear view of the product information system of FIG. 42 having a rear portion 742 of the housing 700 disconnected from a front portion 740. Referring to FIGS. 41-45, in order to connect the card 702 to the housing 700, the insertion beam 716 of the card 702 is axially aligned with the insertion channel 762 of the housing 700 (shown in FIG. 43). Once aligned, the card 702 is urged toward the insertion channel 762 in the direction of arrow 800 (shown in FIG. 43), so that the insertion beam 716 enters the insertion channel 762. As the insertion beam 716 passes into the insertion channel 762, the insertion beam 716 moves into the interior chamber 750. During such movement, the ramped protuberances 788 of the guide fins 784 push the insertion beam 716 forward until the slot 730 of the card 702 encounters the tab 770, at which point, the tab 770 passes into the slot 730, thereby locking the insertion beam 716, and therefore the card 702, in a secure position with respect to the housing 700. The lower stop 776 provides a barrier past which the insertion beam 716 cannot pass. Further, the lateral guide protuberances 780 provide lateral barriers that laterally restrain the insertion beam 716.

The communication device 724 is retained behind the button 754. Tap indicia can be disposed on the button 754. An individual can tap a device in proximity to the button 754 to gain access to product information via the communication device 724, as described herein.

In order to remove the card 702 from the housing 700, an individual presses the button 752 inwardly in the direction of arc 810. As the button 752 inwardly pivots about the stem 756, an interior surface of the circular body 760 engages the insertion beam 716, thereby inwardly bending the insertion beam 716 to rearwardly deflect off the ramped protuberances 788, and push the slot 730 off and away from the tab 770. Once the slot 730 of the card 702 disengages the tab 770, the card 702 can be upwardly pulled in the direction of arrow 820, thereby pulling the insertion beam 716 upwardly out of and away from the insertion channel 762.

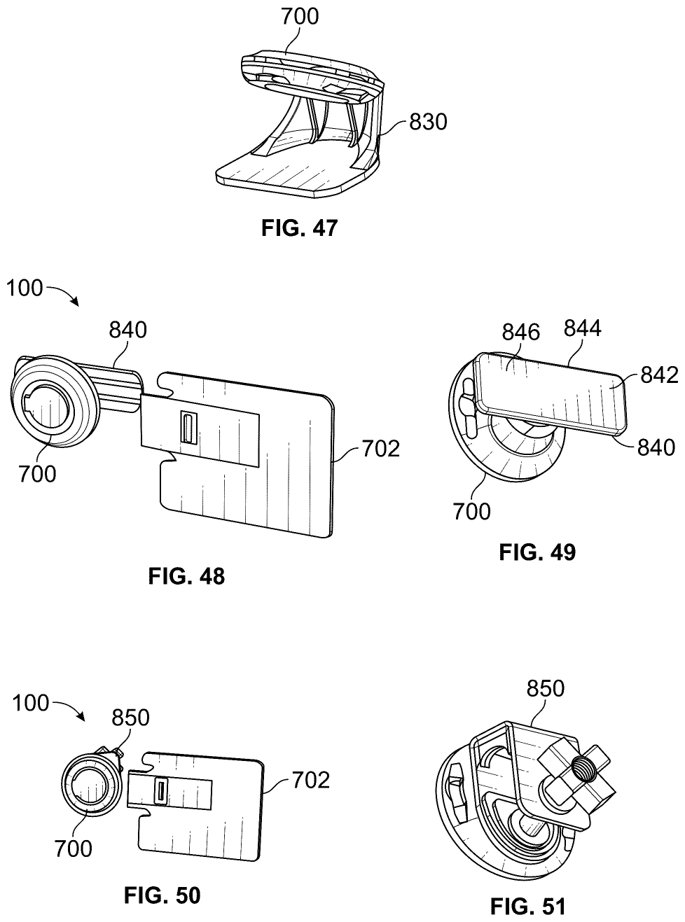

FIG. 46 illustrates an isometric front view of a product information system 100 having a card 702 disconnected from a housing 700, according to an example of the present disclosure. FIG. 47 illustrates an isometric rear view of the housing 700 of FIG. 46 secured to a stand 830, according to an example of the present disclosure. Referring to FIGS. 46 and 47, the housing 700 can be coupled to the stand 830, such as shown and described with respect to FIGS. 11-15.

FIG. 48 illustrates an isometric front view of a product information system 100 having a card 702 disconnected from a housing 700, according to an example of the present disclosure. FIG. 49 illustrates an isometric rear view of the housing 700 of FIG. 48 secured to a rail 840. Referring to FIGS. 48 and 49, the housing 700 can be coupled to the rail 840. The rail 840 can include a coupler 842 on a rear surface 844. In at least one example, the coupler 842 includes a flexible layer 846 of nanotechnology gel, which is configured to secure the product information system 100 to a surface. Instead of the flexible layer 846 of nanotechnology gel, the coupler 842 can be or otherwise include a suction cup assembly. As another example, the coupler 842 can include the suction cup assembly having a flexible layer of nanotechnology gel.

FIG. 50 illustrates an isometric front view of a product information system 100 having a card 702 disconnected from a housing 700, according to an example of the present disclosure. FIG. 51 illustrates an isometric rear view of the housing 700 of FIG. 50 secured to a retaining clip 850. In this example, the housing 700 can be coupled to the retaining clip 850, which can secure to a rail, such as shown and described with respect to FIGS. 21-26.

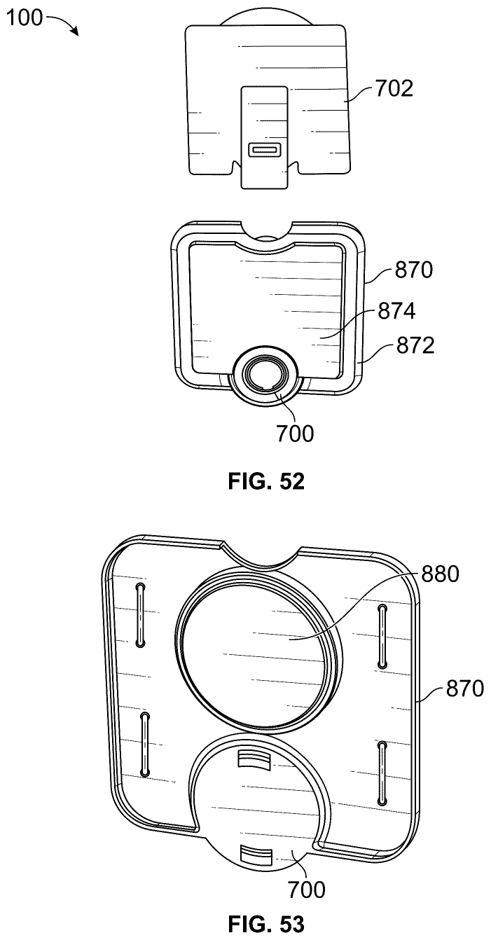

FIG. 52 illustrates an isometric front view of a product information system 100 having a card 702 disconnected from a housing 700, according to an example of the present disclosure. FIG. 53 illustrates an isometric rear view of the housing 700 of FIG. 52. In this example, the housing 700 includes one or more panels 870 connected to the disk-shaped body shown in FIGS. 41-45. For example, two panels 870 can connect together along with the front portion 740 and the rear portion 742 (shown in FIGS. 41-45, for example). The panel(s) 870 provide an outer frame 872, which can retain an interior window or opening 874. Optionally, the interior section can be opaque. A coupler 880 can be disposed on the rear surface. The coupler 880 can include a flexible layer of nanotechnology, as described herein, and/or optionally a suction cup assembly.

Referring to FIGS. 41-53, the housing 700 can be coupled to various stands, support bodies, rails, and/or the like. The housing 700 and card 702 can be sized and shaped differently than shown, and can be coupled to other devices, structures, components, other than shown.

Further, the disclosure comprises examples according to the following clauses:

Clause 1. A product information system comprising:
a card including an insertion beam, wherein the card retains a communication device, wherein the communication device is configured to provide information regarding one or more products in response to being engaged by a device of an individual; and
a housing including an insertion channel leading into an interior chamber, wherein the insertion beam is configured to be inserted into the insertion channel, and wherein the housing is configured to retain the insertion beam within the interior chamber to secure the card to the housing.

Clause 2. The product information system of Clause 1, wherein the card further comprises a main panel, wherein the insertion beam downwardly extends from the main panel.

Clause 3. The product information system of Clauses 1 or 2, wherein the insertion beam retains the communication device.

Clause 4. The product information system of any of Clauses 1-3, wherein the insertion beam is formed by a lower portion of an extension beam folded about a fold line, and wherein the communication device is retained within a folded portion of the insertion beam.

Clause 5. The product information system of any of Clauses 1-4, wherein the card further comprises a slot, and wherein the housing further comprises a tab, wherein the tab is retained within the slot when the housing retains the insertion beam.

Clause 6. The product information system of Clause 5, wherein the housing further comprises one or more guide fins having ramped protuberances that push the slot onto the tab when the insertion beam is inserted into the insertion channel.

Clause 7. The product information system of Clause 6, wherein the housing further comprises:
a lower stop; and
lateral guide protuberances, wherein the lower stop and the lateral guide protuberances are configured to restrain the insertion tab when inserted into the insertion channel.

Clause 8. The product information system of any of Clauses 1-7, wherein the housing comprises a front portion removably connected to a rear portion.

Clause 9. The product information system of any of Clauses 1-8, wherein the housing further comprises a button configured to be pressed to release the insertion beam from the insertion channel.

Clause 10. The product information system of Clause 9, wherein the button comprises a tap indicia, wherein the tap indicia provides an area where the individual can tap the device to engage the communication device.

Clause 11. The product information system of any of Clauses 1-10, wherein the housing further comprises a coupler including a flexible layer of nanotechnology gel configured to secure the housing to a surface.

Clause 12. A method for a product information system comprising:
a card including an insertion beam, wherein the card retains a communication device, wherein the communication device is configured to provide information regarding one or more products in response to being engaged by a device of an individual; and
a housing including an insertion channel that leads into an interior chamber, wherein the insertion beam is configured to be inserted into the insertion channel, and wherein the housing is configured to retain the insertion beam within the interior chamber to secure the card to the housing,
the method comprising:
inserting the insertion beam of the card into the insertion channel of the housing; and
retaining the insertion beam within the interior chamber.

Clause 13. The method of Clause 12, further comprising retaining the communication device within the insertion beam.

Clause 14. The method of Clauses 12 or 13, further comprising:
forming the insertion beam by folding a lower portion of an extension beam about a fold line; and
retaining the communication device within a folded portion of the insertion beam.

Clause 15. The method of any of Clauses 12-14, wherein said retaining comprises retaining a tab of the housing within a slot of the card.

Clause 16. The method of Clause 15, wherein said inserting comprises pushing the slot onto the tab by ramped protuberances of one or more guide fins of the housing.

Clause 17. The method of Clause 16, further comprising restraining the insertion tab by a lower stop and lateral guide protuberances when the insertion tab is inserted into the insertion channel.

Clause 18. The method of any of any of Clauses 12-17, further comprising pressing a button of the housing to release the insertion beam from the insertion channel.

Clause 19. The method of any of Clauses 12-18, further comprising securing the housing to a surface by a coupler including a flexible layer of nanotechnology gel.

Clause 20. A product information system comprising:
a card including:
   a main panel;
   an insertion beam downwardly extending from the main panel; and
   a slot formed in one or both of the main panel or the insertion beam,
   wherein the insertion beam retains a communication device, wherein the communication device is configured to provide information regarding one or more products in response to being engaged by a device of an individual, wherein the insertion beam is formed by a lower portion of an extension beam folded about a fold line, and wherein the communication device is retained within a folded portion of the insertion beam; and
a housing including:
   an insertion channel leading into an interior chamber;
   a tab;
   one or more guide fins having ramped protuberances;
   a lower stop;
   lateral guide protuberances;
   a button; and
   a coupler including a flexible layer of nanotechnology gel configured to secure the housing to a surface,
   wherein the insertion beam is configured to be inserted into the insertion channel, wherein the housing is configured to retain the insertion beam within the interior chamber to secure the card to the housing, wherein the ramped protuberances push the slot onto the tab when the insertion beam is inserted into the insertion channel, wherein the tab is retained within the slot when the housing retains the insertion beam, wherein the lower stop and the lateral guide protuberances are configured to restrain the insertion tab when inserted into the insertion channel, and wherein the button is configured to be pressed to release the insertion beam from the insertion channel.

As described herein, examples of the present disclosure provide product information systems and methods, such as can be used with a product holder system, that is configured to allow an individual to quickly, and easily determine information regarding a product, service, and/or the like.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the parameters of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A product information system comprising:
a card including an insertion beam, wherein the card retains a communication device, wherein the communication device is configured to provide information regarding one or more products in response to being engaged by a device of an individual; and
a housing including an insertion channel leading into an interior chamber, wherein the insertion beam is configured to be inserted into the insertion channel, and wherein the housing is configured to retain the insertion beam within the interior chamber to secure the card to the housing.

2. The product information system of claim 1, wherein the card further comprises a main panel, wherein the insertion beam downwardly extends from the main panel.

3. The product information system of claim 1, wherein the insertion beam retains the communication device.

4. The product information system of claim 1, wherein the insertion beam is formed by a lower portion of an extension beam folded about a fold line, and wherein the communication device is retained within a folded portion of the insertion beam.

5. The product information system of claim 1, wherein the card further comprises a slot, and wherein the housing further comprises a tab, wherein the tab is retained within the slot when the housing retains the insertion beam.

6. The product information system of claim 5, wherein the housing further comprises one or more guide fins having ramped protuberances that push the slot onto the tab when the insertion beam is inserted into the insertion channel.

7. The product information system of claim 6, wherein the housing further comprises:
a lower stop; and
lateral guide protuberances, wherein the lower stop and the lateral guide protuberances are configured to restrain the insertion tab when inserted into the insertion channel.

8. The product information system of claim 1, wherein the housing comprises a front portion removably connected to a rear portion.

9. The product information system of claim 1, wherein the housing further comprises a button configured to be pressed to release the insertion beam from the insertion channel.

10. The product information system of claim 9, wherein the button comprises a tap indicia, wherein the tap indicia provides an area where the individual can tap the device to engage the communication device.

11. The product information system of claim 1, wherein the housing further comprises a coupler including a flexible layer of nanotechnology gel configured to secure the housing to a surface.

12. A method for a product information system comprising:
a card including an insertion beam, wherein the card retains a communication device, wherein the communication device is configured to provide information regarding one or more products in response to being engaged by a device of an individual; and
a housing including an insertion channel that leads into an interior chamber, wherein the insertion beam is configured to be inserted into the insertion channel, and wherein the housing is configured to retain the insertion beam within the interior chamber to secure the card to the housing,
the method comprising:
inserting the insertion beam of the card into the insertion channel of the housing; and
retaining the insertion beam within the interior chamber.

13. The method of claim 12, further comprising retaining the communication device within the insertion beam.

14. The method of claim 12, further comprising:
forming the insertion beam by folding a lower portion of an extension beam about a fold line; and
retaining the communication device within a folded portion of the insertion beam.

15. The method of claim 12, wherein said retaining comprises retaining a tab of the housing within a slot of the card.

16. The method of claim 15, wherein said inserting comprises pushing the slot onto the tab by ramped protuberances of one or more guide fins of the housing.

17. The method of claim 16, further comprising restraining the insertion tab by a lower stop and lateral guide protuberances when the insertion tab is inserted into the insertion channel.

18. The method of claim 12, further comprising pressing a button of the housing to release the insertion beam from the insertion channel.

19. The method of claim 12, further comprising securing the housing to a surface by a coupler including a flexible layer of nanotechnology gel.

20. A product information system comprising:
a card including:
a main panel;
an insertion beam downwardly extending from the main panel; and
a slot formed in one or both of the main panel or the insertion beam,
wherein the insertion beam retains a communication device, wherein the communication device is configured to provide information regarding one or more products in response to being engaged by a device of an individual, wherein the insertion beam is formed by a lower portion of an extension beam folded about a fold line, and wherein the communication device is retained within a folded portion of the insertion beam; and
a housing including:
an insertion channel leading into an interior chamber;
a tab;
one or more guide fins having ramped protuberances;
a lower stop;
lateral guide protuberances;
a button; and
a coupler including a flexible layer of nanotechnology gel configured to secure the housing to a surface,
wherein the insertion beam is configured to be inserted into the insertion channel, wherein the housing is configured to retain the insertion beam within the interior chamber to secure the card to the housing, wherein the ramped protuberances push the slot onto the tab when the insertion beam is inserted into the insertion channel, wherein the tab is retained within the slot when the housing retains the insertion beam, wherein the lower stop and the lateral guide protuberances are configured to restrain the insertion tab when inserted into the insertion channel, and wherein the button is configured to be pressed to release the insertion beam from the insertion channel.
